(19) United States
(12) Patent Application Publication
(10) Pub. No.: US 2018/0093286 A1
(43) Pub. Date: Apr. 5, 2018

(54) MANUAL PUMP

(71) Applicant: APTAR FRANCE SAS, Le Neubourg (FR)

(72) Inventor: Gilles JOURDIN, Combon (FR)

(73) Assignee: APTAR FRANCE SAS, Le Neubourg (FR)

(21) Appl. No.: 15/559,536

(22) PCT Filed: Mar. 17, 2016
(86) PCT No.: PCT/FR2016/050592

§ 371 Date: Sep. 19, 2017

(30) Foreign Application Priority Data
Mar. 20, 2015 (FR) 15 52338

(51) Int. Cl. B05B 11/00; F04B 49/03; F04B 9/14

(52) U.S. Cl. CPC B05B 11/3001; F04B 9/14; F04B 49/03

(57) ABSTRACT

A manual pump (P) for associating with a fluid reservoir (R), the pump (P) comprising a pump body (B) that defines a slide cylinder (F), and further comprising a pump chamber (C), the pump (P) further comprising an outlet valve (V) and an inlet (E1) so as to take the fluid into the pump chamber (C) from the reservoir (R);
the manual pump being characterized in that:
   the pump chamber (C) does not have an inlet valve; and
   one fraction of the dose of fluid stored in the pump chamber (C) is discharged through the outlet valve (V) towards the dispenser orifice (O), and the other fraction of the dose of fluid stored in the pump chamber (C) is discharged into the reservoir (R) through the inlet (E1).

The present invention relates to a manual pump for a fluid dispenser, the pump being for associating with a fluid reservoir, thereby forming a fluid dispenser. The pump comprises a pump body that defines a slide cylinder for a piston that is secured to an actuator rod, the pump further comprising a pump chamber in which a dose of fluid is put under pressure on each actuation. The pump further comprising an outlet valve that is arranged between the pump chamber and a dispenser orifice so as to dispense the fluid from the pump chamber, the pump further comprising an inlet so as to take the fluid into the pump chamber from the reservoir. This is an entirely conventional design for a pump in the fields of perfumery, cosmetics, and pharmacy.

In general, the volume of the pump chamber is determined and unchanging for a particular pump model. In other words, in general it is not possible to modify the volume of the pump chamber. However, it is possible to adjust the volume of the pump chamber by acting on the top dead center corresponding to the rest position of the actuator rod and of the piston, as proposed in document FR 2 719 084, for example. In that document, provision is made to depress the hoop into the pump body to a greater or lesser extent, so as to adjust the volume of the pump chamber. This acts on the height of the stroke of the piston. Consequently, the pusher mounted on the pump is movable over a shorter height, which may disconcert the user who has the impression of not being able to depress the pusher fully.

Naturally, another solution for reducing the volume of the pump chamber is to make a completely new small-capacity pump. However, that involves considerable cost, given that the components of the miniature pump need to be designed and molded in specific manner.

An object of the present invention is to remedy the above-mentioned drawbacks of the prior art by defining a standard-capacity manual pump that is suitable for delivering a dose of fluid that is smaller than the volume of the pump chamber, without reducing the stroke of the piston and of the actuator rod, and without reducing the volume of the pump chamber. In other words, an object of the present invention is to dispense a dose of fluid that is incomplete relative to the capacity or maximum dose of the pump chamber.

To do this, the present invention proposes that:
the pump chamber does not have an inlet valve; and
one fraction of the dose of fluid stored in the pump chamber is discharged through the outlet valve towards the dispenser orifice, and the other fraction of the dose of fluid stored in the pump chamber is discharged into the reservoir through the inlet.

It should be observed that the pump does not have an inlet valve, which is quite unusual, indeed exceptional, for a pump in the fields of perfumery, cosmetics, or pharmacy. Thus, the fluid that passes through the inlet is injected back into the fluid reservoir. However, the fluid passing through the inlet could be stored, at least temporarily, in a buffer reservoir that may optionally communicate with the fluid reservoir.

In an embodiment of the invention, the inlet forms a constriction that constricts the flow of fluid between the reservoir and the pump chamber. This constriction creates considerable head loss that may be likened to the head loss of a leaky valve that is not leaktight. The constriction is sufficient for the pressure in the pump chamber to increase until it exceeds the opening threshold of the outlet valve, which pressure oscillates in the range 2 bars to 6 bars on standard pumps.

Advantageously, the slide cylinder presents a cylinder cross-section Sf and the inlet presents an inlet cross-section Se, the ratio Sf/Se being greater than 50.

In a practical embodiment, the ratio Sf/Se lies in the range about 75 to 117 with a 100 microliter (μL) dose for a dispensed quantity lying in the range about 15 μL to 30 μL.

In another practical embodiment, the ratio Sf/Se lies in the range about 209 to 469 with a 70 μL dose for a dispensed quantity lying in the range about 15 μL to 30 μL.

In both embodiments, the cylinder cross-section Sf may be about 33 square millimeters (mm²). The inlet cross-section Se may be about 0.05 mm² to 0.5 mm².

In an embodiment, the inlet is formed by the pump body.

In another embodiment, the inlet is formed by an insert that is fitted in the pump body at the bottom of the pump chamber.

In still another embodiment, the inlet is formed by a dip tube that is secured to the pump body. The pump body may form a connection sleeve in which a constriction bushing is received, the dip tube being force-fitted into the constriction bushing so as to create a constricted flow section forming the inlet. In a variant, the dip tube presents an inside diameter that is substantially constant over its entire length, but of diameter that is small compared to conventional dip tubes.

It can be said that about 50% to 90% of the dose of fluid that is put under pressure in the pump chamber is returned through the inlet.

The invention also defines a fluid dispenser comprising a fluid reservoir on which there is mounted a manual pump as defined above, the inlet enabling a fraction of the dose of fluid that is put under pressure in the pump chamber to be returned directly to the fluid reservoir.

The spirit of the invention resides in returning a fraction of the fluid through the inlet of the pump chamber that does not have an inlet valve, so that the entire dose stored in the pump chamber is not discharged through the outlet valve and the dispenser orifice. By accurately determining the section and the length of the inlet, it is possible to adjust accurately the volume of the fractional dose that is discharged through the outlet valve and the dispenser orifice.

In the figures:

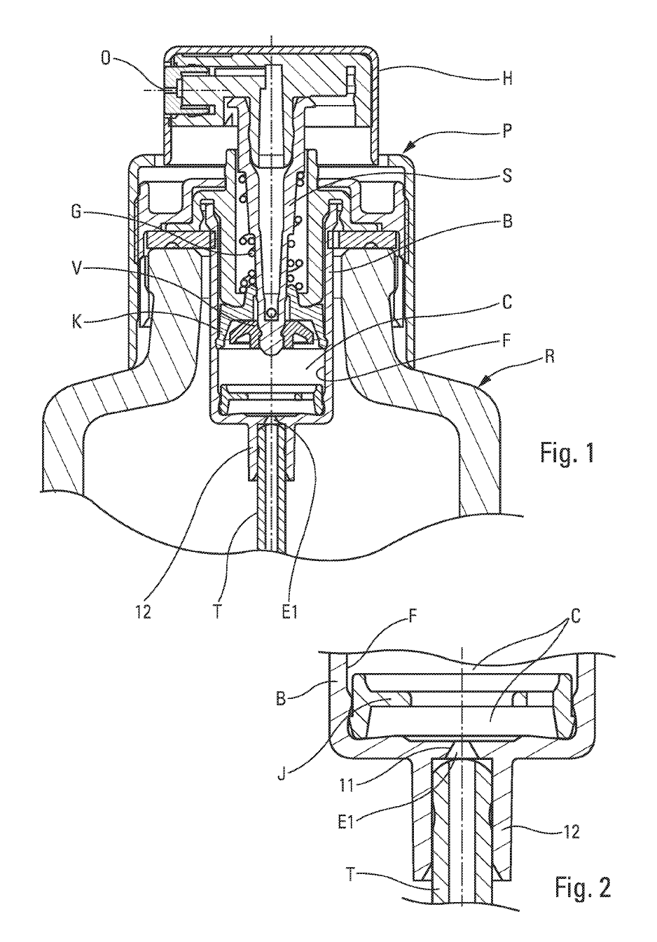

FIG. 1 is a vertical-section view through a fluid dispenser incorporating a pump in a first embodiment of the invention;

FIG. 2 is a larger-scale view of the bottom portion of the FIG. 1 pump;

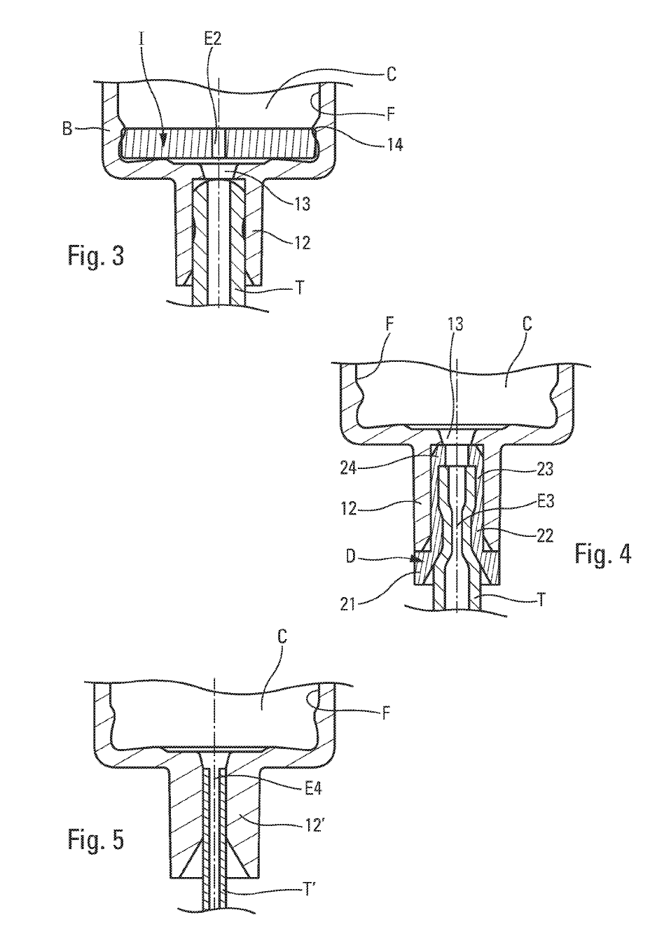

FIG. 3 is a view similar to the view in FIG. 2, showing a second embodiment of the invention;

FIG. 4 is a view similar to the view in FIG. 2 for a third embodiment of the invention; and

FIG. 5 is a view similar to FIG. 2 for a fifth embodiment of a pump of the invention;

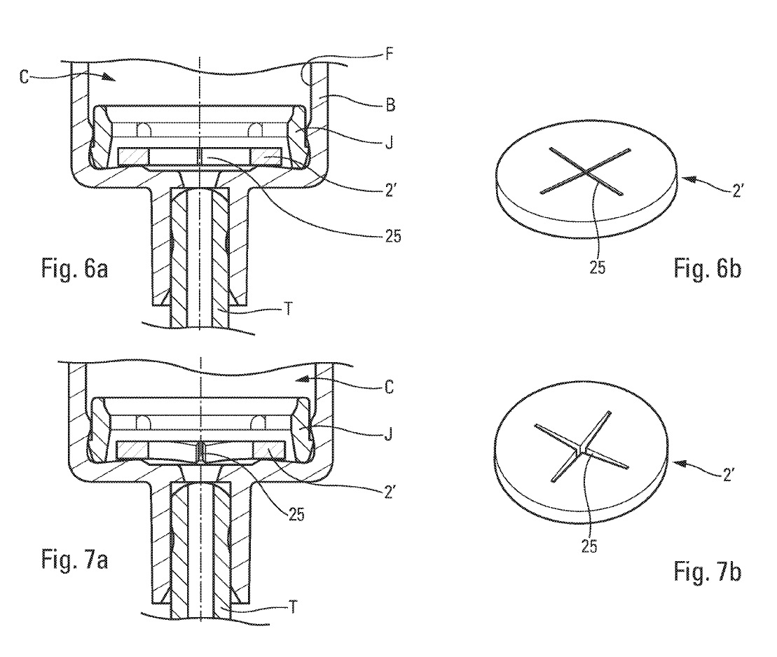

FIG. 6a is a vertical section view through a pump in another embodiment that incorporates an inlet valve, showing it in its rest state;

FIG. 6b is a perspective view of the FIG. 6a inlet valve;

FIG. 7a is a view similar to the view in FIG. 6a with the inlet valve subjected to pressure;

FIG. 7b is a perspective view of the FIG. 7a inlet valve;

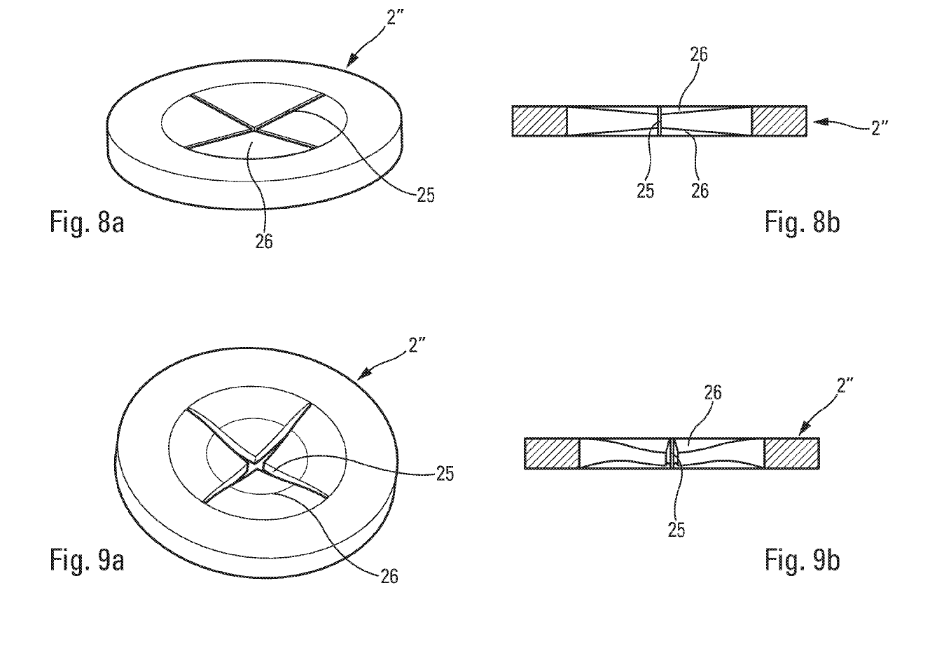

FIGS. 8a and 8b show a variant embodiment for an inlet valve in its rest state; and

FIGS. 9a and 9b show the FIGS. 8a and 8b valve when deformed by pressure.

Reference is made firstly to FIGS. 1 and 2 in order to describe in detail a complete dispenser incorporating a manual pump P in the first embodiment.

The fluid dispenser includes a fluid reservoir R for containing a fluid, e.g. that may be a fragrance, an eau de toilette, a lotion, a cream, a gel, a pharmaceutical, etc. The fluid reservoir R may be made of any appropriate material and may present any configuration, given that the reservoir itself is not critical to the present invention. By way of example, the reservoir R may be provided with a neck N that defines a constricted opening in which the manual pump P is housed.

In entirely conventional manner, the pump P includes a pump body B that defines a fluid inlet EI that is defined by a frustoconical wall 11 in this embodiment. The pump body B forms a connection sleeve 12 that extends downwards around the inlet E1. The sleeve 12 receives a dip tube T that extends inside the reservoir R into the proximity of its bottom, or into contact therewith. In the figures, it can be seen that the inside section of the dip tube T is greater than the minimum section of the inlet E1 at the top of the frustoconical wall 11. Consequently, the inlet E1 defines a constriction that constricts the flow of fluid. The body B also defines a slide cylinder F that has a shape that is cylindrical, preferably circular. The pump P also includes an actuator rod S that is covered by a pusher H that defines a dispenser orifice O. The actuator rod S serves as a support to the piston K and to an outlet valve V. The piston K is mounted to slide in leaktight manner inside the slide cylinder F of the pump body B. The pump P thus defines a pump chamber C for filling with fluid from the reservoir R, through the dip tube T and the inlet E1. When the pump chamber C is full of fluid, the user can press on the pusher H so as to press the actuator rod S into the pump body B. The piston K is mounted to slide over the actuator rod S against a pre-compression spring G, so that the outlet valve V opens as soon as the pressure inside the pump chamber C has reached a predetermined threshold that lies in the range about 2 bars to 6 bars. More precisely, at rest, the piston K bears against the outlet valve V in leaktight manner. When the piston K slides over the actuator rod S, it lifts off the outlet valve V, thereby opening an outlet passage for the fluid under pressure that is discharged through the actuator rod S until it reaches the dispenser orifice O where it is dispensed optionally as a spray. When the user relaxes the pressure on the pusher H, the actuator rod S returns to its rest position under the action of a return spring. The volume of the pump chamber C is thus once again in its maximum state. This design is entirely conventional for a pump in the fields of perfumery, cosmetics, and pharmacy. Without going beyond the ambit of the invention, the design of the outlet valve could be different, given that the outlet valve is not critical to the present invention. It is even possible to envisage that the manual pump does not have an outlet valve: for example, it is possible to envisage a pusher H fitted with a built-in shutter that acts as an outlet valve.

With reference to FIG. 2, it can be seen more clearly that the pump chamber C does not have an inlet valve, which is not conventional for a fragrance or cream pump. The inlet E1 communicates directly with the inside of the pump chamber C. The presence of a stroke limiter J should be observed, which stroke limiter is fastened to the inside of the pump body B and normally serves to limit the movement of an inlet valve, which is absent in this embodiment. Specifically, the FIG. 1 pump is a conventional pump that is normally fitted with an inlet valve in the form of a disk that is held captive between the inlet E1 and the limiter J. In the present invention, the valve disk has been removed, but the limiter is still in place: allowing fluid to flow without head loss.

In the invention, the inlet E1 presents a flow section that is small compared to the diameter/section of the slide cylinder F, and even to the inside diameter of the dip tube T. FIG. 2 shows only a single through hole as inlet, but a plurality of through holes could be provided together forming the inlet E1, without going beyond the ambit of the invention.

Thus, when the user depresses the pusher H and thus puts the fluid stored in the pump chamber C under pressure, the outlet valve V opens so as to allow one fraction of the fluid to pass from the pump chamber, while another fraction of the fluid from the pump chamber is returned into the dip tube T through the inlet E1. By acting on the flow section of the inlet E1, the proportions of fluid discharged through the actuator rod S and through the inlet E1 can be adjusted.

By way of example, the cross-section Se of the inlet E1 may lie in the range about 0.05 mm² to 0.5 mm². The cylinder F may present a cross-section Sf of about 30 mm², for example. The ratio Sf/Se is preferably greater than 50.

In the table below, all of the values for the cylinder F, for the inlet E1, and for their ratios are given for two pumps, one having an original dose of 70 μL, and the other having an original dose of 100 μL. Each of the inlets E1 were dimensioned to deliver respective doses of 15 μL and of 30 μL.

| | | | | | | Original | |
|---|---|---|---|---|---|---|---|
| Orig- | | | | | Deliv- | dose/ | Body |
| inal | | body | | Hole | ered | Deliv- | section/ |
| dose | Body Ø | section | Hole Ø | section | dose | ered | hole |
| (μL) | (mm) | (mm²) | (mm) | (mm²) | (μL) | dose | section |
| 70 | 6.5 | 33.18 | 0.45 | 0.159 | 15 | 4.67 | 209 |
| | | | 0.3 | 0.071 | 30 | 2.33 | 469 |
| 100 | | | 0.75 | 0.442 | 15 | 6.67 | 75 |
| | | | 0.6 | 0.283 | 30 | 3.33 | 117 |

Naturally, it is possible to determine the size of the inlet E1 as a function of the desired delivered dose, so that, for example, about 50% to 90% of the dose of fluid that is put under pressure in the pump chamber C escapes through the inlet E1.

FIGS. 3 to 5 show three other embodiments for creating inlets of the invention, which inlets may have the same characteristics of size and of ratio with the cylinder F as the inlet E1.

In FIG. 3, the inlet E2 is formed by an insert I that is engaged in the pump body B at the bottom of the pump chamber C. In this embodiment, the insert is in the form of a disk or washer of circular shape that is perforated, preferably at its center, with a hole of small section that forms the inlet E2. The insert may be held in place by an annular bead 14 that is formed at the bottom end of the cylinder F. The inlet may be cylindrical, as shown in FIG. 3, or frustoconical like the inlet E1. The inlet E2 is advantageously in alignment with a through opening 13 that is formed by the pump body B, around which through opening there extends the connection sleeve 12 that is engaged with the dip tube T.

The FIG. 3 embodiment presents the advantage of being able to implement the present invention using a standard pump, merely by replacing its inlet valve with the insert I.

In FIG. 4, the inlet E3 is formed by a constricted flow section of the dip tube T. More precisely, a constriction bushing D is engaged inside the connection sleeve 12, and the dip tube T is itself force-fitted into the constriction bushing D, which causes the dip tube T to be constricted locally. In the embodiment shown in FIG. 4, the bushing D includes an outer rim 21 that is situated outside the sleeve 12 and that comes into abutment against its bottom annular edge. A constriction segment 22 that is connected to the rim 21 extends inside the sleeve 12 and presents an inside diameter that is small. A relaxation segment 23 extends the constriction segment 22 inside the sleeve 12 and presents an inside diameter that is greater than the diameter of the constriction segment 22. Finally, the bushing D may form an abutment segment 24 that is adjacent to the opening 13 of the pump body B, and that presents an inside diameter that is greater than the outside diameter of the dip tube T. Thus, when the dip tube, which may be of an entirely standard type and diameter, is force-fitted into the bushing D, it is greatly deformed by constricting on passing through the constriction segment 22, such that its inside diameter is small, thereby forming the inlet E3. After passing through the constriction segment 22, the dip tube T may relax and once again increase in diameter at the relaxation segment 23, and come into contact with the abutment segment 24, as shown in FIG. 4.

In addition to forming the inlet E3, the constriction bushing D also contributes to improving the hold of the dip tube T in the connection sleeve 12. It should also be observed that a standard pump (with the inlet valve removed) and a standard dip tube may be used, resulting in low cost. Only the bushing D constitutes an additional part, however it is very easy to mold.

In FIG. 5, the inlet E4 is formed by a dip tube T′ that in particular presents an inside diameter that is small compared to a standard dip tube. Specifically, a standard dip tube presents a standard outside diameter of 1.2 millimeters (mm), and a standard inside diameter of 0.9 mm, i.e. a flow cross-section of 0.64 mm². In order to satisfy the requirements of the invention, it is thus necessary to use a non-standard dip tube having a smaller flow section, e.g. of about 0.1 mm². It is also necessary to adapt the connection sleeve 12′ to the outside diameter of the dip tube T, or to use an adapter/reducer. It should be observed that the inside diameter of the dip tube is substantially constant (no notable deformation) over its entire length, and particularly at the sleeve 12′.

Without going beyond the ambit of the invention, it is possible to envisage using an adapter bushing that is suitable for receiving a dip tube without notable deformation, but including a small section, e.g. at the abutment segment 24. It is also possible to envisage a coupler bushing with which the dip tube does not penetrate into the connection sleeve. This makes it possible to use a standard pump (without inlet valve) and a standard dip tube, resulting in low cost.

By means of the invention, it is possible to reduce the quantity of fluid dispensed from a pump chamber of considerably greater volume. In the field of perfumery for example, the doses of fluid dispensed each time the pump is actuated generally lie in the range about 50 microliters (μL) to 150 μL. For a pump that normally dispenses 100 μL doses, the present invention makes it possible to reduce the volume of fluid dispensed to about 50 μL, or even to about 10 μL, i.e. a reduction lying in the range about 50% to 90%, while naturally preserving the total stroke of the pump. The inlet, which may be in the form of one or more holes, passages, sections, etc., may present a single or combined section lying in the range about 0.05 mm² to 0.5 mm², with a preferred section of about 0.1 mm².

FIGS. 6a to 9b show another embodiment that uses an inlet valve 2′, 2″ at the inlet of the pump chamber C. The general structure of the pump may be similar to the structure in FIG. 1, with a stroke limiter J fitted in stationary manner in the bottom portion of the pump body C. The inlet valve 2′, 2″ is in the form of a disk or washer that is made of or cut out from a flexible material. At rest and when the pump chamber is put under pressure, the valve bears against its seat, being flattened to a greater or lesser extent. As can be seen more clearly in FIGS. 6b, 7b, 8a, and 9a, the valve is perforated by a slot 25 that is in the shape of a cross in this embodiment. Other configurations are possible (simple line). When the valve is at rest (FIGS. 6b, 8a), the slot is closed: its opposite edges are touching. When the pump chamber is put under pressure, the valve is flattened against its seat, but the slot 25 opens (FIGS. 7b, 9a): its opposite edges are not in contact. Fluid under pressure in the pump chamber C may thus pass through the open slot and return into the reservoir through the dip tube T. When the pump chamber has been emptied and tends to fill once again, suction is established inside, thereby causing the valve member 25 to lift off its seat. Fluid from the reservoir may then fill the chamber. Given that the valve lifting off causes the fluid to flow rapidly, the slot 25 remains closed.

In other words, the slot 25 is open only while fluid is being dispensed, and remains closed at rest and while the pump chamber is being filled. It can thus be said that the slot 25 performs a valve function that is open only while dispensing. The valve/slot is itself incorporated in a conventional inlet valve.

In addition, as a result of the slot 25 being deformable under the effect of pressure, its open state depends on the amplitude of the pressure: the greater the pressure, the greater the flow section of the slot. In other words, when the user actuates the pump vigorously by pressing hard and fast on the pusher, the slot 25 opens wide and allows a quantity of fluid to pass that is greater than when the user actuates the pump gently or with moderation. Thus, the quantity of fluid returned towards the reservoir depends on the user's actuation dynamics. When the user wishes a spray that is intense but brief, the pusher is pressed hard. In contrast, when the user wishes a spray that is long and light, the pusher is pressed gently. Use is thus entirely intuitive.

FIGS. 8a to 9b show a variant embodiment in which the slot 25 is formed in a dish 26 that may extend on both faces. This makes it possible to reduce the wall thickness of the valve at the slot 25 so as to impart more flexibility thereto, and thus greater capacity for opening.

Clearly, the embodiment in FIGS. 6a to 9b is not covered by the claims of the present patent application, but may be the subject of a divisional application, or serve as a basis for a priority claim.

1. A manual pump (P) for a fluid dispenser, the pump being for associating with a fluid reservoir (R), thereby forming a fluid dispenser, the pump (P) comprising a pump body (B) that defines a slide cylinder (F) for a piston (K) that is secured to an actuator rod (S), the pump (P) further comprising a pump chamber (C) in which a dose of fluid is put under pressure on each actuation, the pump (P) further comprising an outlet valve (V) that is arranged between the pump chamber (C) and a dispenser orifice (O) so as to dispense the fluid from the pump chamber (C), the pump (P) further comprising an inlet (E1; E2; E3; E4) so as to take the fluid into the pump chamber (C) from the reservoir (R);
wherein:
the pump chamber (C) does not have an inlet valve; and
one fraction of the dose of fluid put under pressure in the pump chamber (C) is discharged through the outlet valve (V) towards the dispenser orifice (O), and the other fraction of the dose of fluid put under pressure in the pump chamber (C) is discharged into the reservoir (R) through the inlet (E1; E2; E3; E4).

2. A manual pump (P) according to claim 1, wherein the inlet (E1; E2; E3; E4) forms a constriction that constricts the passage of fluid between the fluid reservoir (R) and the pump chamber (C).

3. A manual pump (P) according to claim 1, wherein the slide cylinder (F) presents a cylinder cross-section (Sf) and the inlet (E1; E2; E3; E4) presents an inlet cross-section (Se), the ratio Sf/Se being greater than 50.

4. A manual pump (P) according to claim 3, wherein the ratio Sf/Se lies in the range about 75 to 117 with a 100 μL dose for a dispensed quantity lying in the range about 15 μL to 30 μL.

5. A manual pump (P) according to claim 3, wherein the ratio Sf/Se lies in the range about 209 to 469 with a 70 μL dose for a dispensed quantity lying in the range about 15 μL to 30 μL.

6. A manual pump (P) according to claim 3, wherein the cylinder cross-section (Sf) is about 30 mm².

7. A manual pump (P) according to claim 3, wherein the inlet cross-section (Se) is about 0.05 mm² to 0.5 mm².

8. A manual pump (P) according to claim 1, wherein the inlet (E1) is formed by the pump body (B).

9. A manual pump (P) according to claim 1, wherein the inlet (E2) is formed by an insert (I) that is fitted in the pump body (B) at the bottom of the pump chamber (C).

10. A manual pump (P) according to claim 1, wherein the inlet (E3; E4) is formed by a dip tube (T, T′) that is secured to the pump body (B).

11. A manual pump (P) according to claim 10, wherein the pump body (B) forms a connection sleeve (12) in which a constriction bushing (D) is received, the dip tube (T) being force-fitted into the constriction bushing (D) so as to create a constricted flow section forming the inlet (E3).

12. A manual pump (P) according to claim 10, wherein the dip tube (E4) presents an inside diameter that is substantially constant over its entire length.

13. A manual pump (P) according to claim 1, wherein about 50% to 90% of the dose of fluid that is put under pressure in the pump chamber (C) escapes through the inlet (E1; E2; E3; E4).

14. A fluid dispenser comprising a fluid reservoir (R) on which there is mounted a manual pump (P) according to claim 1, the inlet (E1; E2; E3; E4) enabling a fraction of the dose of fluid that is put under pressure in the pump chamber (C) to be returned directly to the fluid reservoir (R).
